(19) United States
(12) Patent Application Publication
(10) Pub. No.: US 2007/0185649 A1
(43) Pub. Date: Aug. 9, 2007

(54) Map database having address points for determining destinations

(75) Inventor: Michael Geilich, Hanover, NH (US)

Correspondence Address: FLIESLER MEYER LLP, 650 CALIFORNIA STREET, 14TH FLOOR, SAN FRANCISCO, CA, 94108, US

(73) Assignee: TELE ATLAS NORTH AMERICA, INC., Lebanon, NH (US)

(21) Appl. No.: 11/351,156

(22) Filed: Feb. 8, 2006

(51) Int. Cl. G01C 21/32

(52) U.S. Cl. 701/208; 340/995.1

(57) ABSTRACT

A user is given location information of a desired place, by providing a map database having an index of street segments, each having one or more street names, zero or more shape points and zero or more address points, the points representing specific positions along a street segment, the address points associated with a house number or address range. A user enters a street address of the desired place into device application software, which returns the location to the user if the desired place is an address point. Otherwise, interpolate the location by finding low and high addresses such as the two closest bracketing addresses from address points, or from one address point and from a street segment end point. The interpolated location will be between the low and high addresses by piece-wise linear interpolation, following the street segment's shape points and is then returned to the user.

### FIELD OF THE INVENTION

The present invention relates to map databases having information for determining locations of specific addresses and, more particularly, to map databases having a data structure that is used for accurately determining the positions or locations of places desired by a user.

### BACKGROUND OF THE INVENTION

In recent years, consumers have been provided with a variety of devices and systems to enable them to locate places on a digital map. The term “place” is a general term used throughout the description of this invention. The term “place” includes street addresses, buildings located at street addresses such as businesses and landmarks, and facilities located at a number of street addresses such as shopping malls and business parks. The variety of devices and systems used by consumers are in the form of in-vehicle navigation systems that enable drivers to navigate over streets and roads, hand-held devices such as personal digital assistants (“PDAs”), personal navigation devices, and cell phones that can do the same, and Internet applications in which users can generate maps showing desired places. The common aspect in all of these and other types of devices and systems is a map database of geographic features and software to access and manipulate the map database in response to user inputs. Essentially, in all of these devices and systems a user can enter a desired place and the returned result will be the position of that place. Typically, users will enter the names of businesses, such as a restaurant, or a destination landmark, such as the Golden Gate Bridge, or a street address and then be returned the location of the requested place. The location may be shown on a map display, or may be used to calculate and display driving directions to the location, or used in other ways.

Map databases provide information about locations of houses and buildings on streets. Map database developers include address data over a given address range for a given street or street segment in map databases. The address range will include a group of building or house numbers corresponding to a given side of the street segment with starting house numbers and positions, ending house numbers and positions, and optionally some intermediate house numbers and positions.

To locate a desired place in response to a user input, the software of the device or system will first determine the street address of the place, then locate the street segment that has an address range containing the desired address, and then perform interpolation within the address range to estimate the position of the place. However, no interpolation algorithm can account for variations in the real world distribution of buildings or house numbers along a given street block. For example, there may be a park at the beginning or in the middle of the block, houses may be distributed along the block non-uniformly, or buildings at the ends of address ranges may not be located exactly at street intersections.

Ideally, building or house numbers at the end of an address range represent real building addresses, minimizing error in interpolating intermediate house numbers. However, this is not always the case. Some map databases are modeled with address ranges using potential building or house numbers at the end points, and this exacerbates the problem of accurately interpolating intermediate building or house numbers. For example, a map database may model address ranges using potential building or house numbers as assigned by the U.S. Postal Service. As an example, in downtown New York City, where streets are broken up into blocks of 100 address numbers, building or house numbers along a block side seldom represent the entire address range and often fall short of completing the range at one end or the other.

Interpolation using the above methods may have errors of fifty percent or more of the length of the street segment. These interpolation errors can translate into tens or hundreds of meters of error, for example, possibly making a desired place out of a user's range of sight for a user who has navigated to the interpolated location.

While interpolation delivers the most precise location the above methods support, it does not guarantee high sub-block accuracy. Yet, high sub-block accuracy is needed to deliver a user precisely to the correct location within a street block.

### SUMMARY OF THE INVENTION

In one aspect, the invention is a map database storable on a storage medium that includes at least one street segment. The street segment may have zero or more address ranges corresponding to the house or building numbers on that segment. The street segment may also have zero or more address points, each corresponding to the position of a building, house number or address range within the address range of the street segment.

In another aspect, the invention includes a map database storable on a storage medium that includes an index of the address information and corresponding positions from a map database having a at least one first data entry, each first data entry identifying a street segment corresponding to an actual street, and for each first data entry the index has zero or more address point entries corresponding to the positions of buildings, house numbers or address ranges within the street segment on either side of the street segment.

In yet another aspect, the invention includes a system for providing a user with information corresponding to a desired place, including a map database having at least one street segment, each street segment having zero or more address ranges and zero or more address points located within the address range, and an applications program for retrieving an address point, if available, located within the address range if available in response to entry of the desired place by the user. If an address point corresponding to a desired place is not available, then the applications program will interpolate between available address points or between an address point and an end point of the address range if available to determine an approximate position of the desired building number. If no address points are available, then the applications program will interpolate between end points of the address range if available to determine an approximate position of the desired building number.

In yet another aspect, the invention is a method for providing a user with location information of the desired place, by retrieving in response to entry by the user of a street name all address points of the street segment associated with the street name. The method then examines the retrieved address points for building address numbers in response to a building address number entered by the user. If any of the retrieved address points corresponds to the entered building address number, then use the corresponding retrieved address point to return to the user the location of the entered building address number. If no retrieved address points correspond to the entered building address number, then interpolate by using the two closest bracketing address points, or one address point and a street segment end point to return the approximate position to the user.

### BRIEF DESCRIPTION OF THE DRAWINGS

FIG. 1 is a schematic illustration of a street segment of one side of one block of a hypothetical main street of a given city and a piecewise linear representation of the street segment formed by drawing straight lines between specific points, called shape points, along the segment.

FIG. 2 illustrates an embodiment of an index of address information containing tables for street segments, address points and shape points and their positions.

FIG. 3 illustrates an embodiment of the compilation of the index of FIG. 2 into an application data structure.

FIG. 4 illustrates an embodiment of pseudocode for the use of address points.

FIG. 5 illustrates an example embodiment as used in a hypothetical Internet-based system.

FIG. 6 illustrates an example embodiment as used on a hand-held device, such as personal digital assistant (PDA).

FIG. 7 illustrates an example embodiment as used on an in-vehicle navigation system, such as a global positioning system (GPS).

FIG. 8 illustrates an example embodiment of address points overlaid on an aerial photo.

FIG. 9 illustrates that embodiments of the map database 504 are separate from a map database application 502.

### DETAILED DESCRIPTION OF THE INVENTION

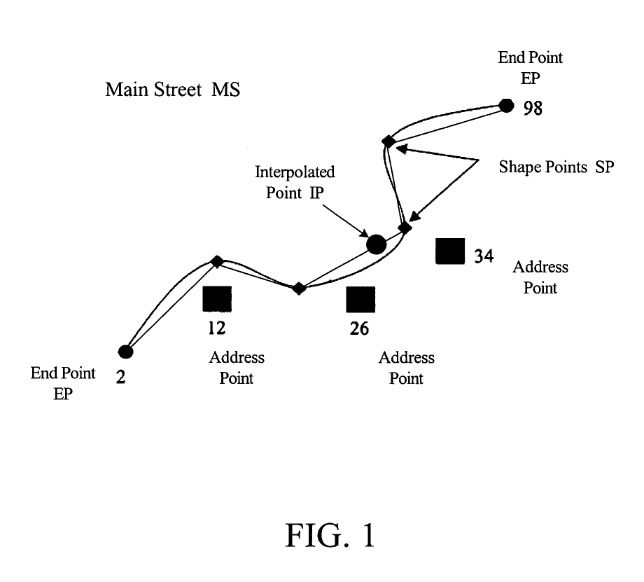

FIG. 1 is a schematic illustration of a street segment of one side of one block of a hypothetical Main Street MS of a given city and a piecewise linear representation of the street segment formed by drawing straight lines between specific points, called shape points SP, along the segment. For this example, assume that this segment of Main Street MS is a residential street having house numbers in an address range of 2-98. The curving line of the street segment represents what would be real-world curves of Main Street MS if Main Street MS was a real street. At the ends of the street segment are end points EP at house number 2 and house number 98. Associated with these end points EP are latitude and longitude coordinates. Additionally, shape points SP are shown along the street segment that are intermediate points used to define the curvature of the segment. Straight lines are used to form a piecewise-linear representation of the real-world curves of the street segment by connecting consecutive shape points SP along the street segment, as well as end points EP to the closest shape points SP at the ends of the street segment. The shape points SP are latitude and longitude points but do not have house numbers associated with them. FIG. 1 also shows three address points 12, 26 and 34, that are latitude and longitude points corresponding to 12 Main Street, 26 Main Street and 34 Main Street. In the United States, there are on the order of one hundred million named and addressed street block sides. Assuming the average street block side contains two real house numbers, each with an address, there are potentially 200 million address points in the United States alone.

In embodiments of the present invention, latitude and longitude of address points, end points and shape points are accurately determined through the use of aerial imagery, satellite photographs, global positioning system (GPS) devices, address geocoding, field survey, compilation from local government maps or other means. In other embodiments, address points, end points and shape points could be determined by other numeric geographic systems besides latitude and longitude.

Although in FIG. 1 address points represent house numbers, in other embodiments, address points may also represent parcels, buildings with more than one house number such as apartment buildings, buildings with more than one number such as commercial buildings, business addresses, and landmarks. In another embodiment, address points may also be places known by more than one name. One example is a vanity address, such as 1 Medical Center, an address that does not make reference to the street address of its location.

For a user who desires the location of 34 Main Street, the prior art, having only end points EP of 2 Main Street and 98 Main Street, would interpolate 34 Main Street to be about a third of way along a straight line (not shown) between the end points EP. However, as shown in FIG. 1 by the address point 34 for house number 34, the actual house number 34 is over halfway down the block side and offset from the street centerline on one side of the street.

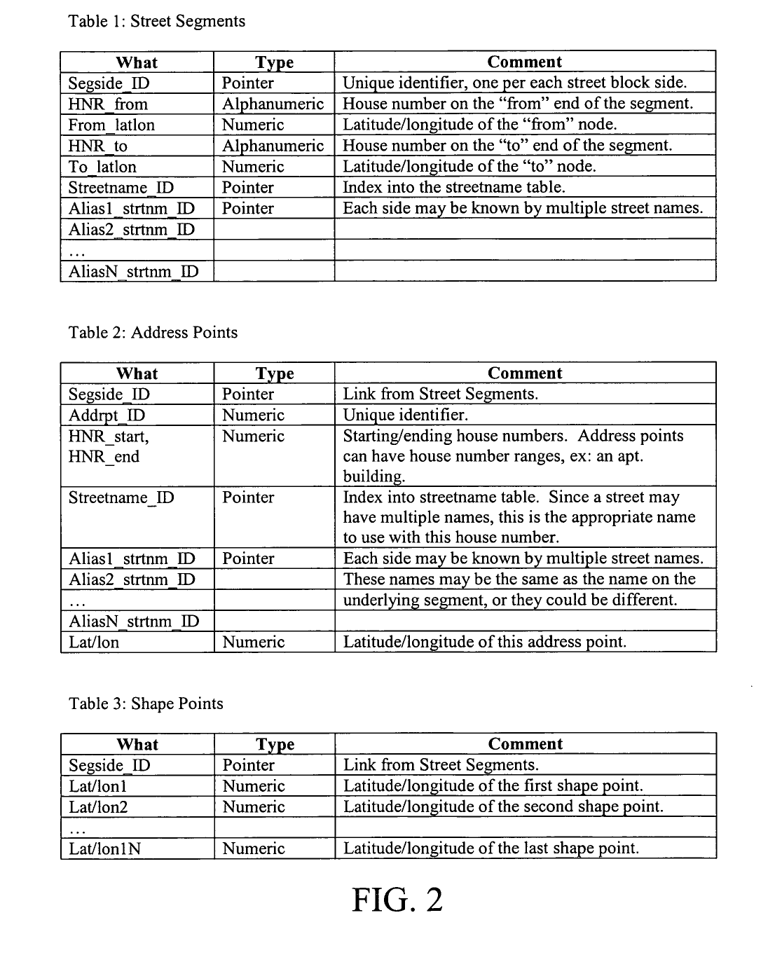

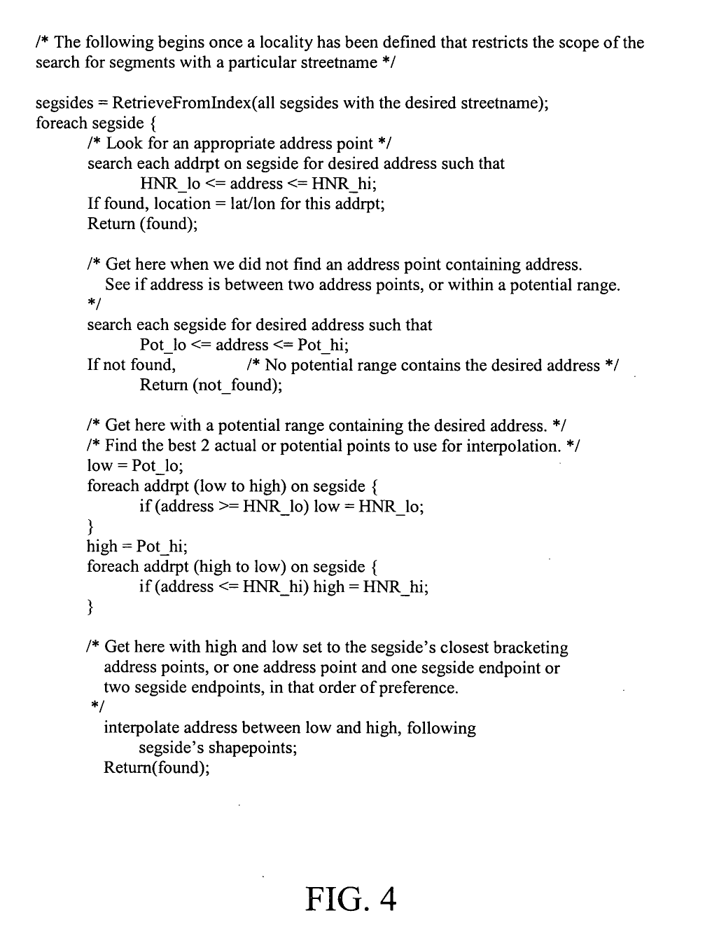

With the present invention, as will be described in more detail below, locations of specific house numbers and address ranges are used to provide and display the correct positioning for any address at the ends of or within any side of a given block. By providing a map database that has address points as described above, the location of a house number or address range for which there is an address point in the map database can be found. This can be accomplished by a direct lookup in an index of address information, such as that shown in FIG. 2. To find the locations of a building for which there is not an address point in the map database, the application software can perform interpolation. For example, with reference to FIG. 1, house number 30 Main Street can be found by interpolating between address point numbers 26 and 34 for 26 Main Street and 34 Main Street to be interpolation point IP, giving a more accurate location than that obtained by interpolating between the end point numbers 2 and 98. A sample algorithm showing both direct lookup as well as interpolation is shown in FIG. 4.

FIG. 2 illustrates an embodiment of an index of address information containing tables for street segments, address points and shape points and their positions. The index of FIG. 2 would be derived from a map database that is deliverable to a map database application developer. The index includes Table 1 entitled “Street Segments,” Table 2 entitled “Address Points” and Table 3 entitled “Shape Points.” The entries shown in Table 1 of FIG. 2 are for a given street segment such as the example street segment shown in FIG. 1.

Table 1 of FIG. 2, which identifies entries for street segments, includes “what,” “type” and “comment” columns. Only the “what” and “type” column entries for Table 1 are required in this embodiment. The “comment” column is not required for this embodiment of Table 1 but is an optional column. The first table entry Segside_ID, whose type is a pointer, is a unique identifier of a street segment, one identifier per each street block side. The next table entry HNR_from, whose type is alphanumeric, is a house number on the “from” end of the street segment. It is part of the address range. From FIG. 1, the house number at the “from” end of the street segment is “2 Main Street.” The next table entry From_latlon, whose type is numeric, is the latitude and longitude of the “from” node. For FIG. 1, From_latlon is the latitude and longitude of “2 Main Street.” The next table entry HNR_to, whose type is alphanumeric, is the house number on the “to” end of the street segment. From FIG. 1, the “to” end of the street segment is “98 Main Street.” The next table entry To_latlon, whose type is numeric, is the latitude and longitude of the “to” node. For FIG. 1, To_latlon is the latitude and longitude of “98 Main Street.” The next table entry Streetname_ID, whose type is pointer, is an index into the streetname table. The remaining table entries Alias1_strnm_ID through AliasN_strnm_ID, whose types are pointers, are used for alternate street names for each side, as each side of the street may be known by multiple street names. For example, in San Francisco, Caesar Chavez Street is also known as Army Street.

Table 2 of FIG. 2, which identifies address points, includes “what”, “type” and “comment” columns. Only the “what” and “type” column entries for Table 2 are required in this embodiment. The “comment” column is not required for this embodiment of Table 2 but is an optional column. The first table entry Segside_ID is a unique identifier of a street segment, one identifier per each street block side and has a type of pointer. Segside_ID is also a link from the street segments Table 1, as Table 1 also has a table entry Segside_ID. The next table entry Addrpt_ID, whose type is pointer, is a unique address point identifier. From FIG. 1, examples of unique address point identifiers are “12 Main Street,” “26 Main Street,” and “34 Main Street.” The next table entry HNR_start, HNR_end, whose type is a pointer, is the starting and ending house numbers for an address point. Address points can have house number ranges, for example an apartment building. However, the starting and ending house number for address point “12 Main Street” is simply 12 and 12. The next table entry Streetname_ID, whose type is a pointer, is an index into the streetname table. Table entries Alias1_strnm_ID through AliasN_strnm_ID, whose types are pointers, are used for alternate street names for each side, as each side of the street may be known by multiple street names. These names may be the same as the names on the underlying segment, a subset of the names on the underlying segment, or other vanity names. For example, an address point may be known by a vanity name such as 1 Medical Center, which is different than the street segment name along which it is located, such as a hypothetical Front Street. Finally, the last table entry Lat/lon, whose type is a pointer, is the latitude and longitude of this address point. For FIG. 1, Lat/lon of address point “12 Main Street” is the latitude and longitude of this address.

Table 3 of FIG. 2, which identifies shape points, includes “what”, “type” and “comment” columns. Only the “what” and “type” column entries for Table 3 are required in this embodiment. The “comment” column is not required for this embodiment of Table 3 but is an optional column. The first table entry Segside_ID is unique identifier of a street segment, one identifier per each street block side and has a type of pointer. Segside_ID is also a link from the street segments Table 1, as Table 1 also has a table entry Segside_ID. The last table entries Lat/lon1 through Lat/lonN, whose types are numeric, are the latitude and longitude of each shape point along the street segment.

A database or index for address information of the present invention will contain many entries. In embodiments of the present invention, not all street segments and their corresponding entries will necessarily have associated address ranges. In embodiments of the present invention, not all street segments and their corresponding database or index entries will necessarily have associated one or more address points. In embodiments of the present invention, not all street segments and their corresponding database or index entries will necessarily have associated one or more shape points. Further, other representations besides an index for address information can be created by skilled programmers, as will be apparent to those skilled in the software art.

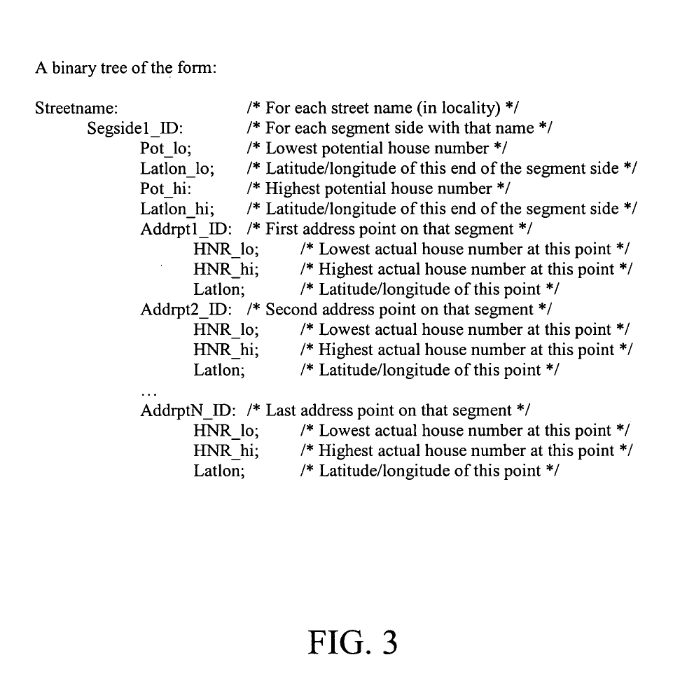

FIG. 3 illustrates an embodiment of the compilation of the index of FIG. 2 into an application data structure. FIG. 3 shows an example of how a map database application developer would compile the index of FIG. 2 into a software application. As shown, the compilation is in the form of a binary tree. For each street name, the data structure includes for each segment side (Segside1_ID) the lowest potential house number of the segment side (Pot_lo), the latitude and longitude of the lowest potential house number of the segment side (Latlon_lo), the highest potential house number of the segment side (Pot_hi) and the latitude and longitude of the highest potential house number of the segment side (Latlon_hi). For each address point on the segment side (Addrpt1_ID through AddrptN_ID), the data structure includes the lowest actual house number at each address point (HNR_lo), the highest actual house number at each address point (HNR_hi) and the latitude and longitude of each address point (Latlon).

FIG. 4 illustrates an embodiment of pseudocode for the use of address points. The pseudocode begins once a locality has been defined by a user that restricts the scope of the search for street segments with a particular street name. First, the pseudocode determines if an address point exists in the database with the correct street name in the locality desired by a user. All segment sides with the desired entered street name are retrieved from the index of FIG. 2, then, for each segment side the software looks for an appropriate address point by searching each address point on a segment side for the desired house number, such that HNR_lo<=address<=HNR_hi, where HNR_lo and HNR_hi are the lowest and highest, respectively, actual house numbers of an address point for the segment side from FIG. 3, and “address” is the desired address. If an address point is found, the location is the latitude/longitude for this address point and there is a return indicating the location has been “found.” For example, if the desired address is 26 Main Street, which is an address point, the location on a map has been found because the latitude and longitude of the address point are known.

If an address point was not found, then the pseudocode determines if the desired house number is between two address points of the segment side, or within the overall address range for that segment. This is accomplished by searching each segment side for the desired address, such that Pot_lo<=address<=Pot_hi, where Pot_lo and Pot_hi are the lowest and highest, respectively, potential house numbers for the segment side from FIG. 3, and “address” is the desired address. For the Main Street example of FIG. 1, the Pot_lo and Pot_hi would be set to the end points of the segment side which are 2 and 98, respectively. If a potential range containing the desired address is not found, then return “not_found.”

If, however, the potential address range does contain the desired address, then the two closest bracketing actual or potential address points to use for interpolation are retrieved. This is accomplished by setting a variable “low” to Pot_lo from FIG. 3, where Pot_lo is the lowest potential house number for the segment side. For each address point, from low to high, on that segment side, if the address>=HNR_lo, then the new value for variable “low” is HNR_lo, where HNR_lo is the lowest actual house number at the address point from FIG. 3 and where “address” is the desired house number. Then, for each address point, from high to low, on that segment side, if the address<=HNR_hi, then the new value for variable “high” is HNR_hi, where HNR_hi is the highest actual house number at the address point from FIG. 3 and where “address” is the desired address. At this point of the pseudocode in FIG. 4, the best two actual or potential points to use for interpolation have been calculated to be “low” and “high,” which were set to the segment side's closest bracketing address points, one address point and one segment side end point, or two segment side end points, in decreasing order of preference.

For example, from FIG. 1, for a desired address of 30 Main Street, the pseudocode in FIG. 4 would calculate “low” and “high” to be 26 and 34, respectively, where 26 and 34 are two address points. For another example from FIG. 1 and for a desired address of 66 Main Street, the pseudocode would calculate “low” and “high” to be 34 and 98, respectively, where 34 is an address point and 98 is a segment side address range end point.

Finally, in FIG. 4, the pseudocode interpolates the desired address to be between “low” and “high” taking into account the piecewise-linear approximation of the curvature of the street segment side as defined by the straight lines connecting the shape points SP, as well as end points EP to the closest shape points SP at the ends of the street segment, as shown in FIG. 1. The pseudocode then returns that the desired address, as interpolated, was “found.” For example, using the example of FIG. 1, the desired address of 30 Main Street will be found by interpolation to be interpolated point IP. Interpolated point IP will be found between address points 26 and 34 along the straight line connecting the two shape points SP located near address points 26 and 34 along the street segment side. The location of the desired address will then be displayed to the user on a map by a map database-to-application converter and device application software.

In one embodiment of the interpolation, a piece-wise linear representation is used in FIG. 4 to approximate the curvature of the street segment side, as shown by the straight lines connecting consecutive shape points SP, as well as end points EP to the closest shape points SP at the ends of the street segments. If no shape points SP are given, a straight line connecting the end points EP is used to represent the segment shape.

In other embodiments of interpolation, if there are no address points for a desired house number or address range on a given street, application software may default to interpolating the position from the address range on the underlying street segment. Or, if some address points exist on the street segment, a combination of an address point and a street segment end point can be used for interpolation. In FIG. 1, for example, the position of house number 66 Main Street can be linearly interpolated to be midway between address point 34 and segment end point house number 98.

The search order that may be used for best positioning is (1) retrieve an actual address point if available on the map database segment; (2) if not available, interpolate between the two numerically closest and bracketing address points on the map segment; (3) if only one bracketing address point is available, interpolate between that address point and the segment end point address from the real or potential address range; and (4) if no address points are available, interpolate between the bracketing address range for the two segment end points from the real or potential address range.

Embodiments of the present invention for interpolation may be used with other linear representations. These linear representations, as used in the FIG. 4 interpolation example, as well as in other embodiments of interpolation, are used when house numbers are distributed uniformly along the street segment. In other embodiments, however, other types of interpolation could be performed. For example, if houses are bunched at one end of a street segment, a logarithmic interpolation algorithm could be used.

The present invention involves changes to a map database, whereas other vendors provide map database-to-application converters and device application software, that utilize the map database or a derived compilation of that data. Device application software access and manipulate the derived map data in response to user inputs. The software's output to the user can be in a list, text, graphical display such as a map or video, audio such as speech, or other type of output. Many GIS, Internet and Navigation applications can use the present invention. These applications include geocoding applications (text/list based), routing/directions applications (graphical/list/speech based) and graphical-based display applications. The applications can include navigation, Internet-based and Geographical Information Systems (GIS) among others. The application can be a mapping program, a navigation program or some other type of program. As discussed above, map application consumers have been provided with a variety of devices and systems to enable them to locate desired places. These devices and systems are in the form of in-vehicle navigation systems which enable a driver to navigate over streets and roads and to enter desired places, hand-held devices such as personal digital assistants (“PDAs”) and cell phones that can do the same, and Internet applications in which users can access maps using or depicting the desired results. For purposes of this disclosure all such results are simply defined as “places.”

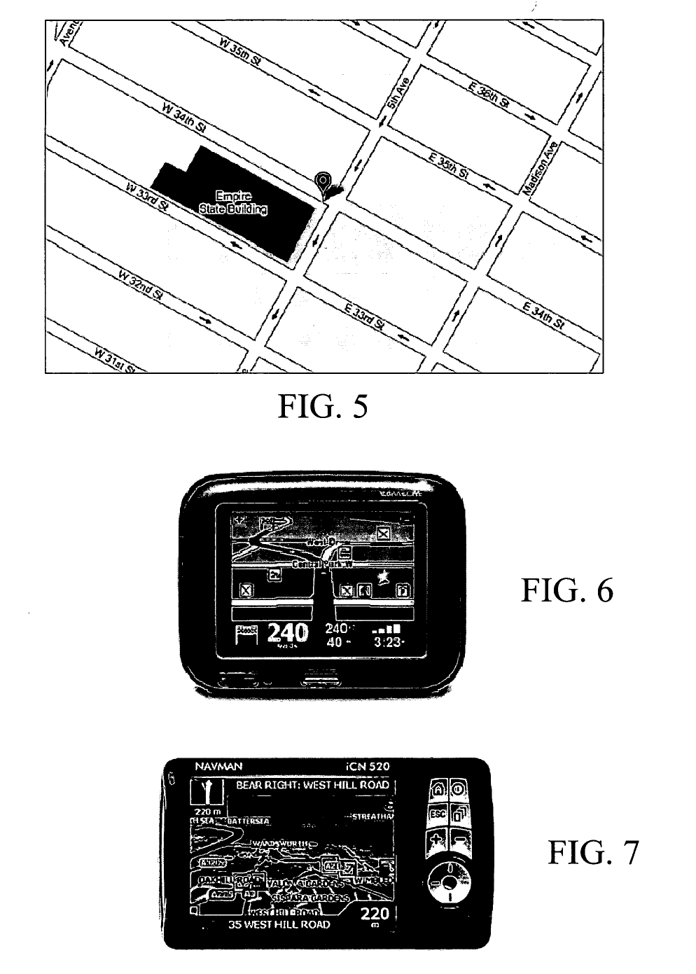

FIG. 5 illustrates an example embodiment as used in a hypothetical Internet-based system. The system could be used on a hand-held device, such as a PDA or a cell phone, or on a computer or laptop. An example search is performed by a user using the hypothetical Internet mapping application for 350 5^{th} Ave., New York, the address of the Empire State Building, as shown next to the “Search” button. The application currently displays the location of the address on the map in the bubble containing a dot near West 34^{th} Street and 5^{th} Avenue. The present invention, on the other hand, would use address points and possibly interpolation to find a more accurate location of the building or the lot where the building is located, which is clearly not at the bubble on the map. The present invention is able to provide more accurate sub-block positioning information for any address at the ends of or within any side of a given block.

FIG. 6 illustrates an example embodiment as used on a portable hand-held device, such as personal digital assistant (PDA). The device could also be a cell phone, for example. On PDA map software, an example search is performed by a user who wants driving directions to 150 Central Park West. The PDA map software utilizes the present invention to accurately display the location of 150 Central Park West using the PDA map software.

FIG. 7 illustrates an example embodiment as used on an in-vehicle navigation system, such as a global positioning system (GPS). On GPS map software, an example search is performed by a driver who wants driving directions to 35 West Hill Road, as shown at the bottom of the GPS map software. The GPS map software utilizes the present invention to accurately display the location of 35 West Hill Road, once the driver reaches his or her destination using the GPS software.

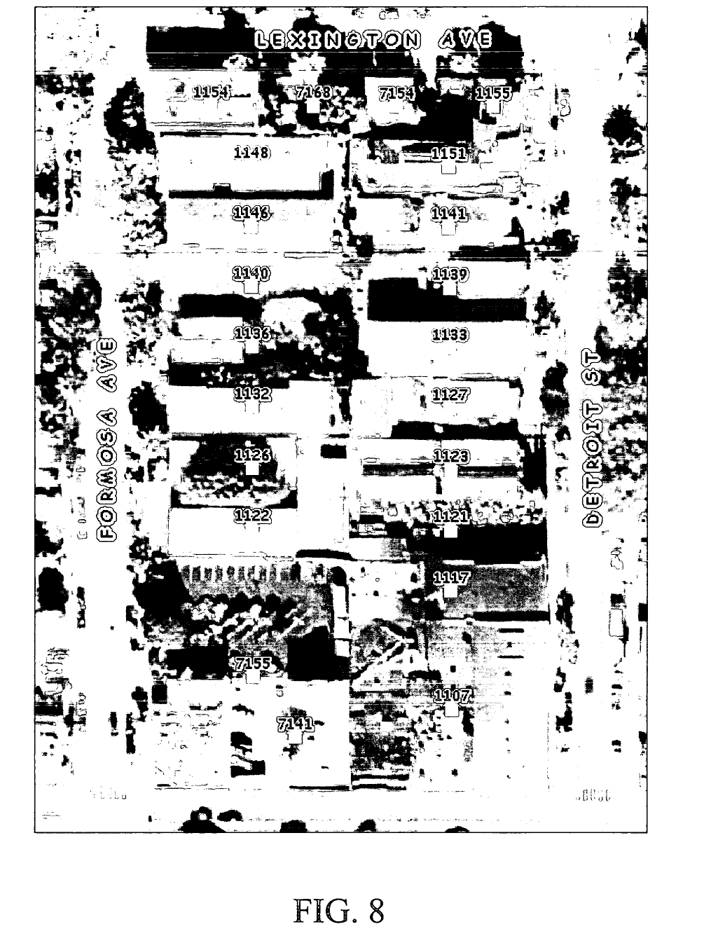

FIG. 8 illustrates an example embodiment showing an example of address points overlaid on a aerial photo. In this example all buildings in the block are designated as address points, so no interpolation is performed to approximate the location of any of the house or building numbers. The names of street segments for Formosa Avenue, Lexington Avenue and Detroit Street are also overlaid onto the aerial photo. For one side of the street segment for Formosa Ave. shown, the address range is 1122 through 1154. For one side of the street segment for Lexington Avenue, the address range is 7168 through 7154. This Lexington Avenue street segment example is a good example of an address range having building locations that do not span the entire block. For one side of the street segment for Detroit Avenue, the address range is 1107 through 1155. This address range is the only one in the photo that has building spanning the entire block.

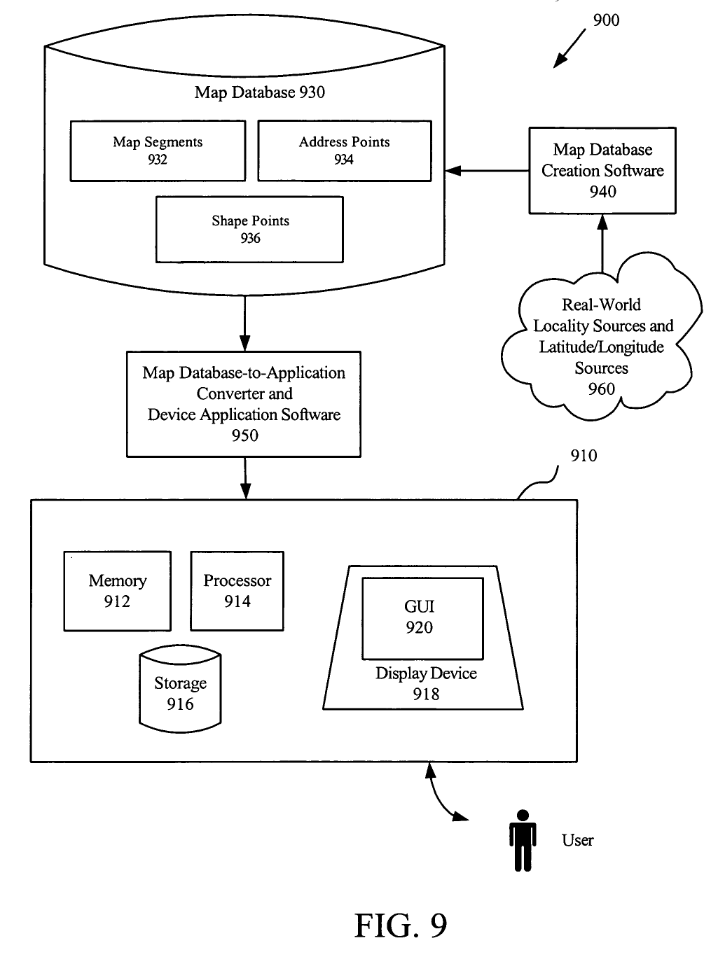

FIG. 9 shows a block diagram of an exemplary system 900 that can be used with embodiments of the invention. Although this diagram depicts components as logically separate, such depiction is merely for illustrative purposes. It will be apparent to those skilled in the art that the components portrayed in this figure can be combined or divided into separate software, firmware and/or hardware components. Furthermore, it will also be apparent to those skilled in the art that such components, regardless of how they are combined or divided, can execute on the same computing device/system or can be distributed among different computing devices/systems connected by one or more networks or other suitable communication means.

As shown in FIG. 9, the system 900 typically includes a computing device 910 which may comprise one or more memories 912, one or more processors 914, and one or more storage devices or repositories 916 of some sort. The system 900 may further include a display device 918, including a graphical user interface or GUI 920 operating thereon by which the system can display maps and other information to a user. The user uses the computing device to request, for example, that a locality be displayed on a map or that driving directions be displayed as a route on a map and/or as text directions.

A map database 930 is shown as external storage to computing device or system 910, but the map database 930 in some instances may be the same storage as storage 916. According to embodiments of the present invention, map database 930 contains a map segments table and index 932, an address points table and index 934, and a shape points table and index 936.

Proprietary map database creation software 940 will use real-world locality sources and latitude/longitude sources 960 to create the map segments, address points and shape points tables and indices 932, 934 and 936, respectively, in the map database 930. Information from the map database 930 is used by a map database-to-application converter and device application software 950, which is ultimately used by a user of the computing device 910. The map database-to-application converter and device application software 950 is shown remote to the user's computing device 910 but may also reside on the user's computing device 910.

Appropriate software coding can readily be prepared by skilled programmers based on the teachings of the present disclosure, as will be apparent to those skilled in the software art. Embodiments of the invention may also be implemented by the preparation of application specific integrated circuits or by interconnecting an appropriate network of conventional component circuits, as will be readily apparent to those skilled in the art.

Embodiments of the present invention include a computer program product which is a storage medium (media) having instructions stored thereon/in which can be used to program a computer to perform any of the processes of embodiments of the present invention. The storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems, including molecular memory ICs, or any type of system or device suitable for storing instructions and/or data.

Stored on any one of the computer readable medium (media), embodiments of the present invention include software for controlling both the hardware of the general purpose/specialized computer or microprocessor, and for enabling the computer or microprocessor to interact with a human user or other mechanism utilizing the results of embodiments of the present invention. Such software may include, but is not limited to, device drivers, operating systems, and user applications. Ultimately, such computer readable media further includes software for performing embodiments of the present invention, as described above.

Included in the programming or software of the general/specialized computer or microprocessor are software modules for implementing the teachings of the present invention. Embodiments of the present invention may be conveniently implemented using a conventional general purpose or a specialized digital computer or microprocessor programmed according to the teachings of the present disclosure, as will be apparent to those skilled in the computer art.

The foregoing description of the present invention has been provided for the purposes of illustration and description. It is not intended to be exhaustive or to limit embodiments of the invention to the precise forms disclosed. Many modifications and variations will be apparent to a practitioner skilled in the art. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalents.

1-31. (canceled)

32. A method for providing a user with location information of a desired place, comprising:
retrieving from a map database street segments and associated address points for street segments corresponding to a user-entered street name of the desired place, such that each address point comprises an address range and a geographic location; and
if a user-entered address number falls within an address range of a particular retrieved address point for any of the retrieved address points, then returning the geographic location of the particular address point.

33-43. (canceled)

44. The method of claim 32, wherein the address range comprises a starting address number, an ending address number, and address numbers between the starting and ending address numbers.

45. The method of claim 44, wherein the starting address number and the ending address number associated with each address point comprise one of the same or different address numbers.

46. The method of claim 32, wherein each address point corresponds to one of a house, a building, a landmark, a facility, a parcel, and a business.

47. The method of claim 32, wherein each address point corresponds to one of a shopping mall, a business park, and a building comprising a plurality of units.

48. The method of claim 32, further comprising:
if the user-entered address number does not fall within an address range of a particular retrieved address point for any of the retrieved address points, then
interpolating an approximate geographic location for the user-entered address number between geographic locations corresponding to two retrieved address points; and
returning the approximate geographic location for the user-entered address number.

49. The method of claim 48, wherein interpolating comprises using two retrieved address points having address ranges numerically closest to and encompassing the user-entered address number.

50. The method of claim 48, further comprising:
retrieving from a map database a first end point and a second end point of the street segment on which the user-entered address number is located such that the first and second end points together represent the address range of the street segment;
wherein the first end point comprises an address range and a geographic location; and
wherein the second end point comprises an address range and a geographic location.

51. The method of claim 50, wherein the first and second end points comprise the ends of the street segment.

52. The method of claim 50, wherein if the first end point's address range and a retrieved address point's address range are numerically closest to and encompass the user-entered address number, interpolating comprises using the retrieved address point's and the first end point's geographic locations.

53. The method of claim 50, wherein if the second end point's address range and a retrieved address point's address range are numerically closest to and encompass the user-entered address number, interpolating comprises using the retrieved address point's and the second end point's and geographic locations.

54. The method of claim 50, wherein if no address points were retrieved, interpolating comprises using the first and second end points' geographic locations.

55. The method of claim 50, wherein
if the first end point does not comprise an actual address range, the first end point comprises a potential address range; and
if the second end point does not comprise an actual address range, the second end point comprises a potential address range.

56. The method of claim 55, wherein the first and second end point potential address ranges each comprise a range of United States Postal Service (USPS) selected numbers.

57. The method of claim 55, wherein the first and second end point potential address ranges each comprise a range of numbers that represent possible addresses for buildings that do not physically exist.

58. The method of claim 55, wherein if the first end point's potential address range and a retrieved address point's address range are numerically closest to and encompass the user-entered address number, interpolating comprises the retrieved address point's and the first end point's geographic locations.

59. The method of claim 55, wherein if the second end point's potential address range and a retrieved address point's address range are numerically closest to and encompass the user-entered address number, interpolating comprises using the retrieved address point's and the second end point's geographic locations.

60. The method of claim 55, wherein if no address points were retrieved and if one or both of the first end point and the second end point are associated with potential address ranges, interpolating comprises using the first and second end points' geographic locations.

61. The method of claim 48, wherein interpolating further comprises:
retrieving from the map database one or more shape points associated with the street segment, such that each shape point comprises a geographic location along a curve of the street segment; and
interpolating by using the geographic locations of the one or more shape points in addition to the geographic locations of the two retrieved address points.

62. The method of claim 61, wherein interpolating further comprises connecting shape points by a straight line to approximate curves of the street segment.

63. The method of claim 61, wherein interpolating further comprises using one of a linear interpolation algorithm that models address numbers as evenly distributed along the street segment and a logarithmic interpolation algorithm that models address numbers as unevenly distributed along the street segment and grouped toward one end of the street segment.

64. The method of claim 52, wherein interpolating further comprises:
retrieving from the map database one or more shape points associated with the street segment, such that each shape point comprises a geographic location along a curve of the street segment; and
interpolating by using the geographic locations of the one or more shape points in addition to the retrieved address point's and the first end point's geographic locations.

65. The method of claim 64, wherein interpolating further comprises:
connecting shape points by a straight line to approximate curves of the street segment; and
connecting the first end point by a straight line to one of the retrieved shape points.

66. The method of claim 64 wherein interpolating further comprises using one of a linear interpolation algorithm that models address numbers as evenly distributed along the street segment and a logarithmic interpolation algorithm that models address numbers as unevenly distributed along the street segment and grouped toward one end of the street segment.

67. The method of claim 53, wherein interpolating further comprises:
retrieving from the map database one or more shape points associated with the street segment, such that each shape point comprises a geographic location along a curve of the street segment; and
interpolating by using the geographic locations of the one or more shape points in addition to the retrieved address point's and the second end point's geographic locations.

68. The method of claim 67, wherein interpolating further comprises:
connecting shape points by a straight line to approximate curves of the street segment; and
connecting the second end point by a straight line to one of the retrieved shape points.

69. The method of claim 67, wherein interpolating further comprises using one of a linear interpolation algorithm that models address numbers as evenly distributed along the street segment and a logarithmic interpolation algorithm that models address numbers as unevenly distributed along the street segment and grouped toward one end of the street segment.

70. The method of claim 54, wherein interpolating further comprises:
retrieving from the map database one or more shape points associated with the street segment, such that each shape point comprises a geographic location along a curve of the street segment; and
interpolating by using the geographic locations of the one or more shape points in addition to the first and second end points' geographic locations.

71. The method of claim 70, wherein interpolating further comprises:
connecting shape points by a straight line to approximate curves of the street segment;
connecting the first end point by a straight line to one of the retrieved shape points; and
connecting the first end point by a straight line to one of the retrieved shape points.

72. The method of claim 70, wherein interpolating further comprises using one of a linear interpolation algorithm that models address numbers as evenly distributed along the street segment and a logarithmic interpolation algorithm that models address numbers as unevenly distributed along the street segment and grouped toward one end of the street segment.

73. The method of claim 70, further comprising connecting the first and second end points by a straight line if no shape points are retrieved from the map database.

74. The method of claim 57, wherein interpolating further comprises:
retrieving from the map database one or more shape points associated with the street segment, such that each shape point comprises a geographic location along a curve of the street segment; and
interpolating by using the geographic locations of the one or more shape points in addition to the retrieved address point's and the first end point's geographic locations.

75. The method of claim 74, wherein interpolating further comprises:
connecting shape points by a straight line to approximate curves of the street segment; and
connecting the first end point by a straight line to one of the retrieved shape points.

76. The method of claim 74, wherein interpolating further comprises using one of a linear interpolation algorithm that models address numbers as evenly distributed along the street segment and a logarithmic interpolation algorithm that models address numbers as unevenly distributed along the street segment and grouped toward one end of the street segment.

77. The method of claim 58, wherein interpolating further comprises:
retrieving from the map database one or more shape points associated with the street segment, such that each shape point comprises a geographic location along a curve of the street segment; and
interpolating by using the geographic locations of the one or more shape points in addition to the retrieved address point's and the second end point's geographic locations.

78. The method of claim 77, wherein interpolating further comprises:
connecting shape points by a straight line to approximate curves of the street segment; and
connecting the second end point by a straight line to one of the retrieved shape points.

79. The method of claim 77, wherein interpolating further comprises using one of a linear interpolation algorithm that models address numbers as evenly distributed along the street segment and a logarithmic interpolation algorithm that models address numbers as unevenly distributed along the street segment and grouped toward one end of the street segment.

80. The method of claim 59, wherein interpolating further comprises:
retrieving from the map database one or more shape points associated with the street segment, such that each shape point comprises a geographic location along a curve of the street segment; and
interpolating by using the geographic locations of the one or more shape points in addition to the first and second end points' geographic locations.

81. The method of claim 80, wherein interpolating further comprises:
connecting shape points by a straight line to approximate curves of the street segment;
connecting the first end point by a straight line to one of the retrieved shape points; and
connecting the second end point by a straight line to one of the retrieved shape points.

82. The method of claim 80, wherein interpolating further comprises using one of a linear interpolation algorithm that models address numbers as evenly distributed along the street segment and a logarithmic interpolation algorithm that models address numbers as unevenly distributed along the street segment and grouped toward one end of the street segment.

83. The method of claim 80, further comprising connecting the first and second end points by a straight line if no shape points are retrieved from the map database.

84. The method of claim 32, wherein each geographic location associated with each address point is associated with a numeric geographic reference system.

85. The method of claim 84, wherein the numeric geographic reference system comprises latitude and longitude.

86. A method of claim 50, wherein for the first and second end points of the street segment, each associated geographic location is associated with a numeric geographic reference system.

87. The method of claim 86, wherein the numeric geographic reference system comprises latitude and longitude.

88. The method of claim 61, wherein each geographic location associated with each shape point is associated with a numeric geographic reference system.

89. The method of claim 88, wherein the numeric geographic reference system comprises latitude and longitude.

90. The method of claim 32, wherein the map database comprises an index of at least one street segment, each street segment defined by an address range, a name and at least one address point, each address point representing house number or address range positions along the at least one street segment, and said index further including a house number or address range associated with each address point;

91. The method of claim 32, wherein the street segment is not associated with an address range.

92. The method of claim 32, wherein the street segment does not have any associated address points.

93. The method of claim 32, wherein the method is run by an applications program.

94. The method of claim 93, wherein the applications program is run on the Internet.

95. The method of claim 93, wherein the applications program is run on a portable hand-held device.

96. The method of claim 93, wherein the applications program is run on an in-vehicle navigation system.

97. The method of claim 93, wherein the applications program comprises a Geographical Information Systems (GIS) based applications program.
